(19) United States
(12) Patent Application Publication
(10) Pub. No.: US 2016/0035322 A1
(43) Pub. Date: Feb. 4, 2016

(54) LIQUID CRYSTAL DISPLAY DEVICE AND DRIVING METHOD THEREOF

(71) Applicant: Japan Display Inc., Tokyo (JP)

(72) Inventors: Yukio Tanaka, Tokyo (JP); Daiichi Suzuki, Tokyo (JP)

(21) Appl. No.: 14/809,764

(22) Filed: Jul. 27, 2015

(30) Foreign Application Priority Data
Jul. 29, 2014 (JP) 2014-153945

(51) Int. Cl. G09G 5/18; G09G 3/36

(52) U.S. Cl. CPC G09G 5/18; G09G 3/3696; G09G 2300/0426

(57) ABSTRACT

Provided is an FFS mode liquid crystal display device capable of preventing the occurrence of flicker when the frame frequency is reduced to 30 to 1 Hz from the conventional frame frequency of 60 Hz in order to reduce the power consumption. In the FFS mode liquid crystal display device, a comb-shaped second electrode is placed on a planar first electrode through an insulating film. When the period of rewriting a video signal to a pixel is one frame, the frame is configured with a first scanning period, a second scanning period, and a break period. The voltage supplied to the pixel electrode in the first scanning period is granter than the voltage supplied to the pixel electrode in the second scanning period with respect to the same video signal, and has the same polarity as the polarity of the voltage supplied to the pixel in the second scanning period.

### CLAIM OF PRIORITY

The present application claims priority from Japanese Patent Application JP 2014-153945 filed on Jul. 29, 2014, the content of which is hereby incorporated by reference into this application.

### BACKGROUND OF THE INVENTION

(1) Field of the Invention

The present invention relates to a display device, and more particularly to a liquid crystal display device capable of preventing flicker during an intermittent drive operation.

(2) Description of the Related Art

A liquid crystal display device includes a TFT substrate in which pixels each having a pixel electrode, a thin film transistor (TFT), and the like are arranged in a matrix form. A counter substrate is disposed opposite the TFT substrate. Further, a liquid crystal is interposed between the TFT substrate and the counter substrate. Then, the liquid crystal display device forms an image by controlling the transmittance of light for each pixel by the liquid crystal molecules.

Liquid crystal display devices are mounted on various types of equipment such as television, car displays such as car navigation systems, and mobile terminals such as notebook computers, tablet computers, and smartphones. For example, in the liquid crystal display devices of twisted nematic (TN) mode and optically compensated bend (OCB) mode, a counter electrode is provided on an upper substrate and a pixel electrode is provided on a lower substrate, in which an electric field is generated between the counter electrode and the pixel electrode. Then, the alignment direction of the liquid crystal molecules contained in a liquid crystal layer interposed between the upper and lower substrates is controlled by the electric field.

Further, in the liquid crystal display devices of in-plane switching (IPS) mode and fringe-field switching (FFS) mode, both the counter electrode (COM electrode in this case) and the pixel electrode are provided on one substrate. Then, the alignment direction of the liquid crystal molecules contained in the liquid crystal layer is controlled by an electric field (fringe electric field) generated between the counter electrode and the pixel electrode. The liquid crystal display device of FFS mode can increase the aperture ratio, having a high brightness and excellent viewing angle characteristics.

The liquid crystal is electrolyzed and converted when a DC component is added as an application voltage. For this reason, an AC drive is used. In particular, in the liquid crystal display device of FFS mode, the transmittance of the liquid crystal varies between when a positive voltage is applied to the pixel electrode and when a negative voltage is applied to the pixel electrode, due to the so-called flexoelectric effect. This is the cause of flicker.

Patent Document 1 (Japanese Patent Application Laid-Open No. 2009-150945) describes a configuration of a liquid crystal display device of FFS mode, in which a voltage for compensating the brightness difference is applied to a conductive film formed in the back surface of the counter substrate, namely, in the surface not facing the liquid crystal layer, in order to correct the change in the brightness between when a positive voltage is applied to the pixel electrode and when a negative voltage is applied to the pixel electrode.

### SUMMARY OF THE INVENTION

In liquid crystal display devices particularly for mobile terminal applications such as smartphones, it is necessary to reduce the circuit power consumption. Low frequency drive and intermittent drive or the like have been proposed as one method to meet this requirement. The low frequency drive is a mode of reducing the circuit power by reducing the drive frequency of the liquid crystal display device, for example, to half or one fourth of the standard conditions. Further, the intermittent drive is a mode of reducing the circuit power by providing a circuit stop period for several display periods after writing for one display period of the liquid crystal display device. The liquid crystal display device is driven at a typical frame frequency of 40 Hz or more when displaying video or the like and is often driven by the intermittent drive when displaying a still image or the like.

In both cases, the period of rewriting video signals in a liquid crystal display unit is increased, and side effects such as motion blur may occur. However, these drive modes can be effective in terms of reduction of circuit power for displaying a still image or the like in which the emphasis is not on video visibility.

Note that in the following description, the time interval for rewriting a video signal to a pixel is called “frame cycle” or “one frame”, and the inverse number is called “frame cycle number” with respect to the low frequency drive and the intermittent drive.

When a DC voltage is applied to the liquid crystal material for a long time, temporal changes occur in the display characteristics due to charge up. Thus, the liquid crystal display device is usually driven by reversing the positive and negative polarities for each frame so that the DC average is nearly zero. However, if there is a deviation of the response characteristics (brightness-voltage characteristics) between the positive and the negative, the brightness differs in the positive and negative frames, and there is a difference in the contrast between light and dark for each frame, resulting in the occurrence of flicker.

It is possible to minimize the occurrence of flicker by applying a small offset voltage to the positive and negative average (DC average values) of the signal or by adjusting the counter electrode potential. However, it is difficult to completely prevent the occurrence of flicker by completely absorbing the temporal shift in the brightness-voltage characteristics as well as the deviation of the optimum conditions between gradation levels.

Inversion methods such as, for example, line inversion, column inversion, and dot inversion are known as means for reducing such a flicker. For example, the line inversion can prevent flicker from being visible, by reversing and distributing the phase of the inversion of the temporal positive/negative polarity to macroscopically compensate the difference in the brightness response between the positive and the negative. Similarly, the column inversion and the dot inversion can prevent flicker from being visible. In this case, the former achieves this by reversing the phase of the inversion of the positive/negative polarity for each column, while the latter reversing in a checked pattern.

Of the inversion methods, the line inversion and the dot inversion perform writing to pixels by reversing the polarity for each line when the screen is scanned. Thus, it is necessary to charge and discharge to the signal lines of the panel for each 1 H period (one horizontal cycle). As a result, the circuit power consumption is increased. On the other hand, the column inversion has no inversion of the polarity in the line direction and is advantageous in terms of the reduction of the circuit power consumption. In the mobile liquid crystal display devices, various types of inversion methods are used according to the product specifications, of which the column inversion method is the most desirable in terms of power reduction.

The following problem occurred when the column inversion drive is performed in the FFS mode liquid crystal display device. That is, although flicker is not particularly when the frame frequency is 60 Hz that is used for typical liquid crystal display devices, flicker is visible when the frame frequency is set to 20 Hz which is one third of the usual frame frequency. In addition, the flicker is more apparent when the frame frequency is further reduced.

An object of the present invention is to provide a liquid crystal display device capable of preventing the occurrence of flicker in the application of low frequency drive or intermittent drive and achieving excellent display quality, as well as a driving method of the liquid crystal display device.

The present invention has been made to overcome the above problems. Some of the major aspects are as follows.

(1) There is provided a liquid crystal display device including: an array substrate including scanning lines extending in a first direction and arranged in a second direction, video signal lines extending in the second direction and arranged in the first direction, and a pixel formed in a region surrounded by the scanning lines and the video signal lines; a counter substrate; and a liquid crystal interposed between the array substrate and the counter substrate. In the pixel, a comb-shaped second electrode is placed on a planar first electrode through an insulating film. When the period of rewriting a video signal to a pixel is one frame, the frame is configured with a first scanning period and a second scanning period. The voltage supplied to the pixel electrode in the first scanning period is greater than the voltage supplied to the pixel electrode in the second scanning period, and has the same polarity as the polarity of the voltage supplied to the pixel electrode in the second scanning period.

(2) In the liquid crystal display device described in (1), the voltage supplied to the pixel electrode in the first scanning period is greater by 0.1% to 3% than the voltage supplied to the pixel electrode in the second scanning period with respect to the same video signal.

(3) In the liquid crystal display device described in (1), the second scanning period is configured with a plurality of scanning periods.

### BRIEF DESCRIPTION OF THE DRAWINGS

FIG. 1 is a schematic plan view of a liquid crystal display device;

FIG. 2 is a cross-sectional view of the structure of a pixel;

FIG. 3 is a chart showing a conventional driving method;

FIG. 4 is a chart showing a driving method according to the present invention;

FIG. 5 is a graph showing the relationship between the voltage in the first scanning period and the voltage in the second scanning period with respect to the same video signal;

FIGS. 6A and 6B are graphs comparing the degree of the brightness change in the driving method of the present invention with the degree of the brightness changed in the conventional driving method;

FIG. 7 is a table comparing the spectral components when the brightness change in the present invention and the brightness change in the conventional driving method are subject to Fourier transform; and

FIGS. 8A and 8B are schematic diagrams illustrating the flexoelectric effect.

### DETAILED DESCRIPTION OF THE PREFERRED EMBODIMENTS

The present invention will be described in detail below by means of preferred embodiments.

### First Embodiment

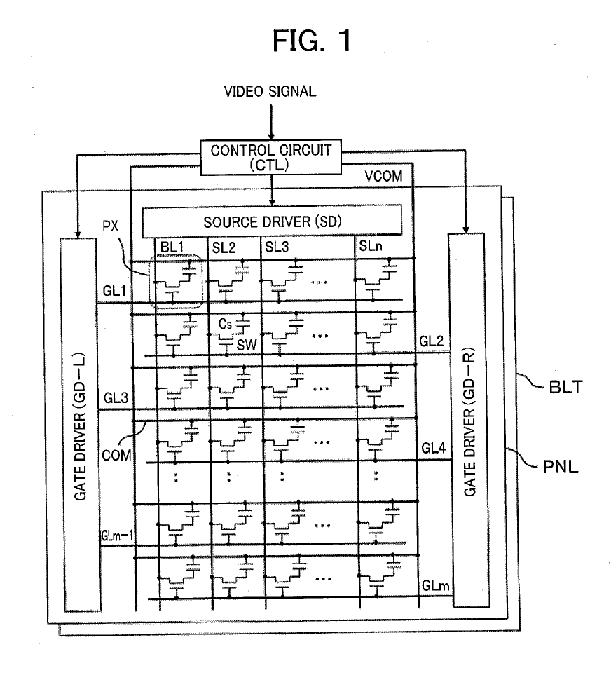

A liquid crystal display device according to an embodiment of the present invention will be described in detail with reference to the drawings. As shown in FIG. 1, a liquid crystal display device according to the present embodiment includes a liquid crystal display panel PNL including a display unit in which display pixels PX are arranged in a matrix of m lines×n columns (where m and n are positive integers). The liquid crystal display device also includes a backlight BLT as an illuminating means for illuminating the liquid crystal display panel from the back side.

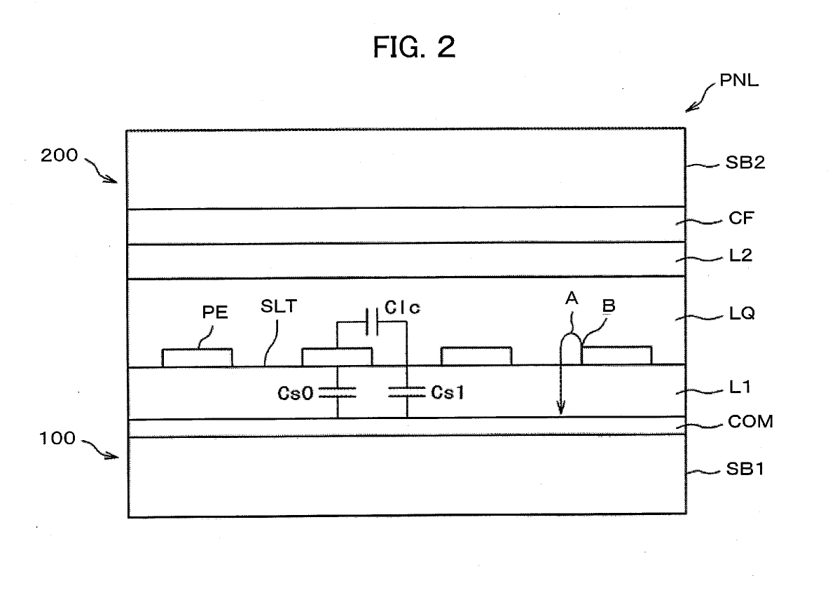

As shown in FIG. 2, the liquid crystal display panel PNL includes a pair of substrates 100 and 200, as well as a liquid crystal layer LQ interposed between the pair of substrates 100 and 200. One of the pair of substrates is a counter substrate 200 including a second transparent insulating substrate SB2, a color filter layer CF including colored layers of red (R), green (G), and blue (B) placed on the second transparent insulating substrate SB2, and an overcoat layer L2 that covers the color filter layer CF. The overcoat layer L2 prevents the material contained in the color filter layer CF from flowing to the liquid crystal layer LQ. Note that the color filter layer may be formed in another substrate 100.

The other one of the pair of substrates is an array substrate 100 including a first transparent insulating substrate SB1, a counter electrode COM, and a plurality of pixel electrodes PE arranged on the counter electrode COM through the insulating layer L1 such as silicon nitride (SiN). The pixel electrode PE is provided for each pixel PX, in which a hole SLT is formed in a slit shape. The counter electrode COM and the pixel electrode PE are transparent electrodes formed of, for example, indium tin oxide (ITO).

In the array substrate 100, the counter electrode COM is formed in a matted manner in the array substrate 100, in which the pixel electrode PE is configured with a comb-shaped electrode with the slit SLT. Note that the end of the slit SLT may be open or closed. Further, in the pixel electrode PE, there may be only one comb-shaped electrode. In this case, the SLT is not present in the comb-shaped electrode.

The array substrate 100 includes: scanning lines GL (GL1, GL2, and so on to GLm) extending along lines in which a plurality of display pixels PX are arranged; signal lines SL (SL1, SL2, and so on to SLn) extending along columns in which a plurality of display pixels PX are arranged; and a pixel switch SW provided in the vicinity of each intersection of the scanning line GL and the signal line SL.

The pixel switch SW includes a thin film transistor (TFT). The gate electrode of the pixel switch SW is electrically coupled to the corresponding scanning line GL. The source electrode of the pixel switch SW is electrically coupled to the corresponding signal line SL. The drain electrode of the pixel switch SW is electrically coupled to the corresponding pixel electrode PE.

The array substrate 100 includes gate drivers GD (GD-L on the left side and GD-R on the right side), and a source driver SD. The plurality of scanning lines GL are electrically coupled to output terminals of the gate drivers GD. The plurality of signal lines SL are electrically coupled to output terminals of the source driver SD.

The gate drivers GD and the source driver SD are provided in the peripheral portion of the display unit. The gate driver GD sequentially applies an ON voltage to the plurality of scanning lines GL to supply the ON voltage to the gate electrode of the pixel switch SW electrically coupled to the selected gate GL. The pixel switch, in which the ON voltage is supplied to the gate electrode, is conductive between the source electrode and the drain electrode. The source driver SD supplies an output signal corresponding to each of the plurality of signal lines SL. The signal supplied to the signal line SL is applied to the corresponding pixel electrode PE through the pixel switch conductive between the source electrode and the drain electrode.

The operation of the gate driver GD and the source driver SD is controlled by a control circuit CTR provided outside the liquid crystal display panel PNL. The control circuit CTR supplies a counter voltage Vcom to the counter electrode COM.

The control circuit CTR has a function of intermittent drive to reduce the drive power. Now, it is assumed as an example that the reference flame frequency of the liquid crystal display device is 60 Hz. In other words, it is assumed that the rewriting of the video signal to the pixel is performed every ( 1/60) sec. The control circuit CTR operates at 60 Hz for video display. However, for still image display or the like in which the emphasis is not on video visibility, the writing (scanning from the top to the bottom of the screen) is performed for ( 1/60) sec, followed by a break period of, for example, ( 1/60) sec, ( 3/60) sec, ( 7/60) sec, or ( 59/60) sec. When the operation of the control circuit CTR is stopped in the break period, the circuit power consumption during this period is substantially zero, so that the circuit power consumption as the time average also including the writing time is reduced to ½, ¼, ⅛ or 1/60, respectively.

In the drive described above, it is necessary to hold data for a long time after writing to each pixel, so that it is desirable to use materials as TFT with a low off leakage current. For example, the TFT using IGZO (oxide of indium (In), gallium (Ga), and zinc (Zn)) typically has a low off leakage current and is said to be suitable for the low frequency drive.

The liquid crystal display device according to the present embodiment is a liquid crystal display device of fringe-field switching (FFS) mode in which an electric field is generated in the liquid crystal layer LQ by the potential difference between the voltage applied to the counter electrode COM and the voltage applied to the pixel electrode PE, to control the alignment direction of the liquid crystal molecules contained in the liquid crystal layer LQ. The amount of transmitted light of the light emitted from the backlight BLT is controlled by the alignment direction of the liquid crystal molecules.

As shown in FIG. 2, a capacitance component Cs0 is naturally generated in a region in which the pixel electrode PE and the counter electrode COM are disposed opposite each other with the insulating layer L1 between them. In addition to this, there exist an auxiliary capacitance component Cs1 and a liquid crystal capacity Clc that correspond to the electric field entering into the liquid crystal layer LQ. When the total capacitance of all the capacities existing between the pixel electrode PE and the counter electrode COM is represented by Cs, it can be expressed by an equivalent circuit with the capacitance Cs interposed between the drain of the TFT and the counter electrode COM.

In FIG. 2, when a signal voltage is applied to the pixel electrode PE, for example, a line of electric force is generated as indicated by the arrow. The liquid crystal molecules are rotated by the electric field, so that the transmittance of the liquid crystal layer is controlled. In FIG. 2, the electric field of the region indicated by A is relatively uniform. However, the electric filed of the region indicated by B is close to the edge of the pixel electrode in which the strength of the electric filed changes and rapidly decreases. Because of this rapid decrease, the polarization of the liquid crystal due to the flexoelectric effect is generated as described below.

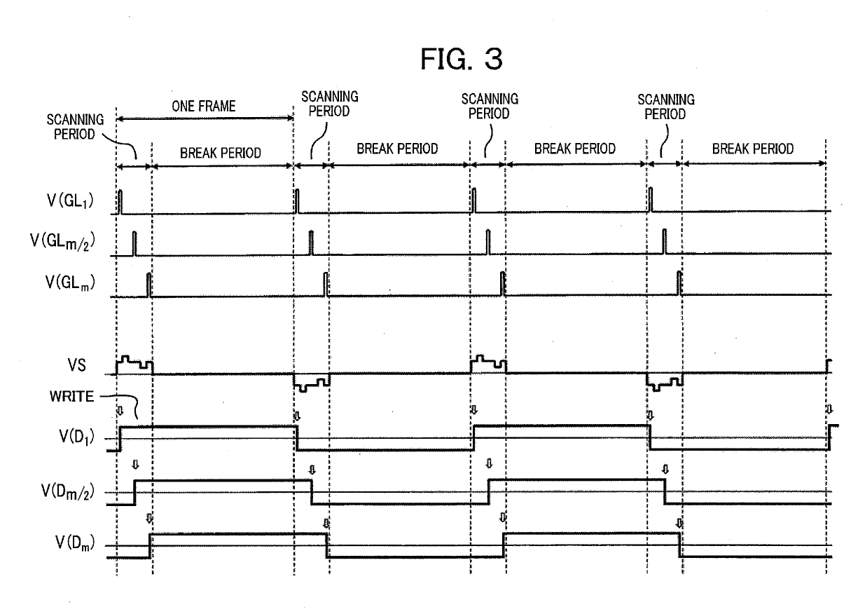

Although the driving method in the intermittent drive of the liquid crystal display device according to the present embodiment will be described below, the conventional driving method is first described as a comparison. FIG. 3 shows the driving waveform of the conventional liquid crystal display device. As described above, in the intermittent drive, one frame period is configured with a scanning period and a following break period.

In the scanning period, the scanning lines GL1, GL2, and so on to GLm are sequentially selected, and the pixel switches SW of each of the corresponding lines are sequentially brought into conduction. Then, the video signal VS output to the signal line 20 from the source driver is written and held in the pixel electrode of each line according to the timing at which the pixel switch of each line is electrically conductive. Note that there are n video signal lines in the display area, but to simplify the description, it focuses on only one signal line, in which VS is the video signal corresponding to the particular signal line.

In the break period, any of the scanning lines GL is not selected, and the holding state of the video signal held in each pixel electrode continues. Although the same operation is performed also in the next frame period, the polarity of the video signal is reversed for every frame, so that the video signal held by the pixel electrode is also reversed for every frame. As a result, the potential applied to the pixel electrode has a rectangular waveform as shown in V (D1), V (D2) and so on to V (Dm).

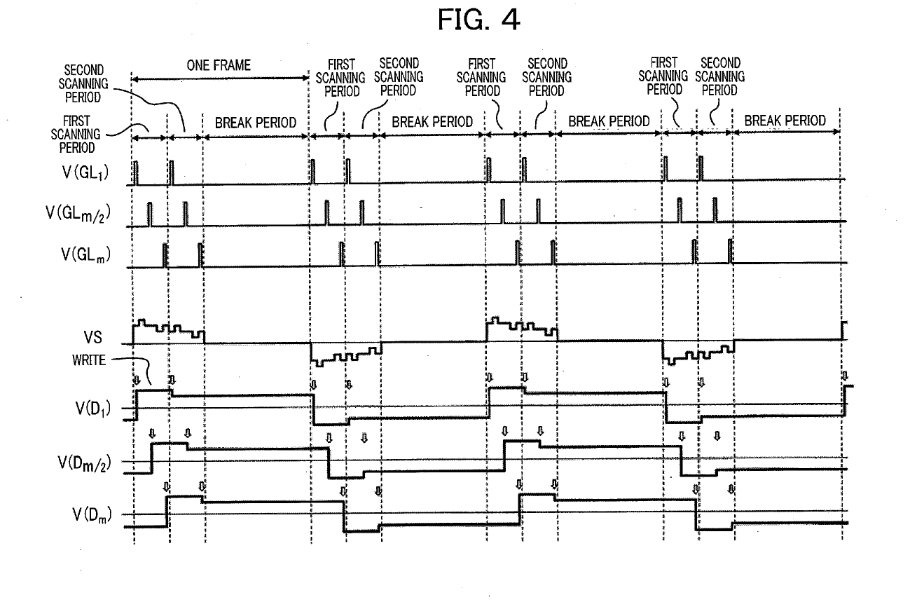

Next, the driving waveform of the liquid crystal display device according to the present invention is shown in FIG. 4, which is different from FIG. 3 in that one frame period is configured with a first scanning period, a second scanning period, and a following break period. In the first scanning period, the scanning lines GL1, GL2, and so on to GLm are sequentially selected, and then the pixel switches SW of each of the corresponding lines are sequentially brought into conduction. Then, the video signal VS output to the signal line 20 from the source driver is written and held in the pixel electrode of each line according to the timing at which the pixel switch of each line is electrically conductive.

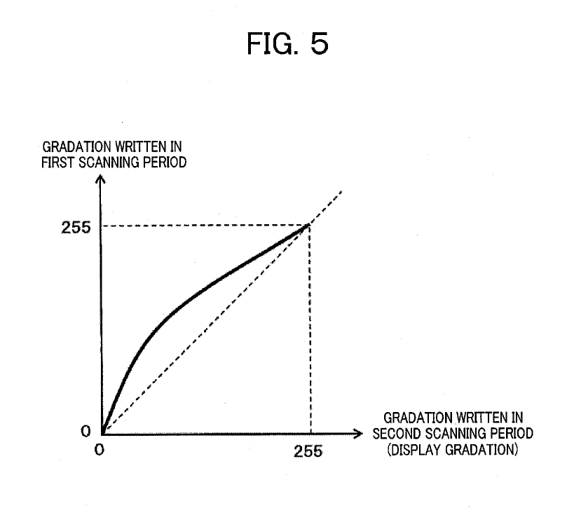

Also the operation is the same as in the second scanning period. In other words, the video signal VS corresponding to each line is written and held in the pixel electrode of each line. Here, although the polarities of the video signal written in each pixel are the same in the first scanning period and in the second scanning period, the gradation level in the two scanning periods is given with the relationship as shown in FIG. 5. In other words, in particular when the gradation of the middle tone region is displayed, the gradation written in the first scanning period is set greater than the gradation written in the second scanning period.

Similarly to the case of FIG. 3, in the break period, any of the scanning lines GL is not selected, and the holding state of the video signal held in each pixel continues. The same operation is performed also in the next frame period. However, the polarity of the video signal is revered for every frame, so that the video signal held in the pixel electrode is also reversed for every frame. As a result, the potential applied to the pixel electrode has a rectangular waveform in which the voltage amplitude is increased only just after the polarity inversion as shown in V (D1), V (D2) and so on to V (Dm).

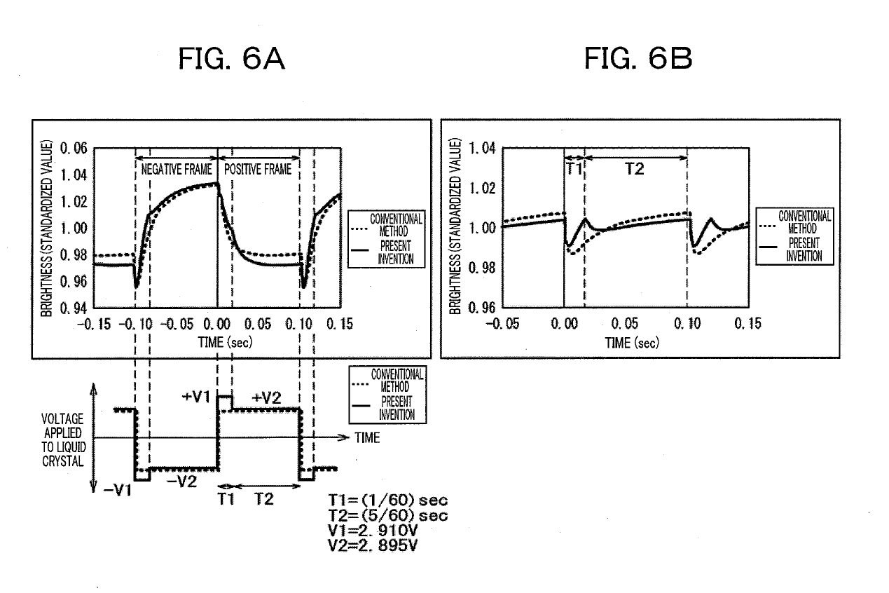

FIG. 6A shows an example of the brightness response waveform of the conventional liquid crystal display device, as well as the brightness response waveform of the liquid crystal display device when the drive of the liquid crystal display device according to the present invention is performed. In this figure, the brightness response for one pixel is measured when the liquid crystal display device is driven at a frame period of 100 msec (frame frequency of 10 Hz). The polarity of the video signal written to the pixel is reversed for every frame. The ranges indicated by the arrows correspond to the negative frame and the positive frame, respectively. As shown in FIG. 6B, the application voltage waveform is a rectangular waveform whose amplitude is V2=2.895 V in the conventional liquid crystal display device. In the case of the present invention, the amplitude of T1=( 1/60) sec just after the polarity inversion is V1=2.910 V, and the remaining T2=( 5/60) sec is V2=2.895 V.

Note that the brightness response waveform of FIG. 6A has characteristics that the brightness of the positive frame and the brightness of the negative frame are significantly different in the conventional liquid crystal display device and in the present invention. This seems to occur because the absolute value of the voltage held by the liquid crystal is not exactly the same in the positive and the negative due to the influence of the parasitic capacitance coupling or the like, or because the liquid crystal itself has an internal electric field due to charge up in which the DC operating point is displaced.

First, the brightness response waveform of the conventional liquid crystal display device will be described. It is observed, as the characteristics, that the brightness is down for several msec just after switching from the positive frame to the negative frame. This is a phenomenon unique to the FFS mode, which seems to occur because the liquid crystal molecules have spontaneous polarization due to the flexoelectric effect of the liquid crystal in which the alignment direction of the liquid crystal molecules changes immediately in response to the inversion of the electric field.

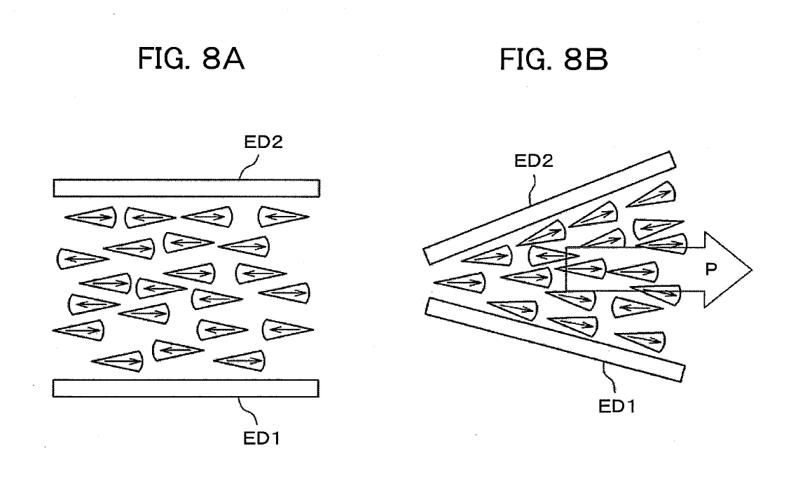

Here, an additional description of the flexoelectric effect is given. The liquid crystal molecule typically has a wedge shape as shown in FIG. 8A, and has spontaneous polarization (which is indicated by the arrow). In the state in which no stress is exerted on the liquid crystal layer, the liquid crystal molecules are randomly oriented and the macroscopic polarization is zero.

However, in a strong electric field region in the vicinity of the edge of the pixel electrode in the FFS mode, a stress is exerted on the liquid crystal as shown in FIG. 8B. At this time, the liquid crystal tries to respond to the deformation by changing the direction of the wedge shape to minimize the elastic energy. In this state, the proportion of the liquid crystal molecules oriented in a specific direction is increased, so that the polarization has a finite value, as seen macroscopically. When the polarity of the voltage applied to the liquid crystal is reversed, the polarization quickly responds (tens of usec to several msec), seemingly resulting in a peak brightness change.

Note that FIGS. 8A and 8B are schematic diagrams showing the state of the electric field. In other words, FIG. 8A shows the state in which a first virtual frame and a second virtual frame are parallel to each other, in which a substantially uniform force is applied to the liquid crystal molecules. This corresponds to the region A of FIG. 2. FIG. 8B shows the state in which the distance between the virtual frames varies and an uneven force is applied to the liquid crystal molecules. This corresponds to the region B of FIG. 2.

Next, FIG. 6B shows the waveform obtained by averaging the positive and negative frames shown in FIG. 6A. In other words, the two waveforms are summed up and divided by two. This corresponds to the brightness response waveform that is macroscopically observed (upon focusing on the area with enough space for including approximately the same numbers of positive and negative polarity pixels), when the liquid crystal display device is driven by the line inversion, the column inversion, the dot inversion, or the like.

The influence of the brightness difference in the positive and negative frames is compensated by averaging the positive and the negative. However, the phenomenon of the temporal lowering of the brightness is observed immediately after the polarity inversion (in the top of the frame). As a result, the brightness change between light and dark at a cycle of 100 msec remains. The brightness lowering in the frame top seems to be the remaining brightness change occurred by the flexoelectric effect as described above, which is left without being compensated by the positive-negative averaging.

Meanwhile, the sensitivity of human eye to flicker is typically known to have frequency dependence, and has characteristics that the lower the frequency is the more it is likely to be perceived as flicker even in the brightness change with the same amplitude. In particular, it is known that the brightness change is not perceived as flicker even if the brightness amplitude is large as long as it has a threshold of around 40 Hz with a frame frequency above 40 Hz, but the brightness change is perceived as flicker at 40 Hz or less even if the amplitude is small.

Thus, if there is a brightness change with amplitude comparable to that of the conventional waveform in FIG. 6B, there is a problem of visibility of flicker when the frame frequency is reduced to 40 Hz or less in the intermittent drive, even if the flicker is not visible in the normal frame frequency of 60 Hz.

Next, the brightness response waveform of the liquid crystal display device of the present invention shown in FIG. 6A will be described. In the liquid crystal display device of the present invention, the amplitude of the voltage applied to the liquid crystal in T1 period immediately after the polarity inversion is increased as compared to the conventional liquid crystal display device. Thus, the brightness response waveform of the present invention is different from the conventional brightness response waveform. Then, as shown in FIG. 6B, the peak width of the brightness response waveform obtained by averaging the positive and negative frames is reduced as compared to that of the conventional brightness response waveform. By applying a voltage with large amplitude immediately after the polarity inversion, the action of increasing the brightness response of the liquid crystal seems to take place to compensate the brightness lowering due to the flexoelectric effect.

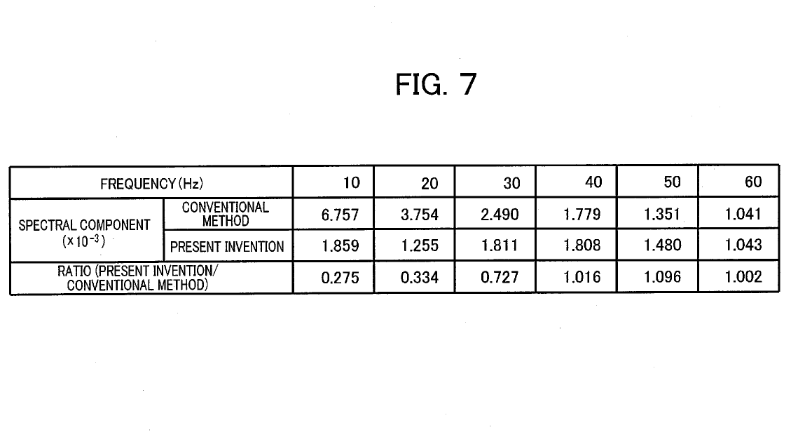

FIG. 7 shows the results of the frequency spectral decomposition with respect to the conventional liquid crystal display device and the present invention, to study the difference in the flicker visibility in the brightness response waveforms between the conventional liquid crystal display device and the present invention shown in FIG. 6B. Here the calculation is performed as follows. That is, if the brightness response waveform is g(t), the frequency is T (=100 msec), and the reference frequency is f (=1/T=10 Hz), g(t) can be expanded in Fourier series as shown in equation 1.

$$\begin{matrix}g ( t ) = \frac{{a}_{0}}{2} + {\sum }_{n = 1}^{∞} \{ {a}_{n} cos ( 2 π nft ) + {b}_{n} sin ( 2 π nft ) \} & Equation 1 \\ {a}_{n} = \frac{2}{T} {\int }_{0}^{T} g ( t ) cos ( 2 π nft ) d t & Equation 2 \\ {b}_{n} = \frac{2}{T} {\int }_{0}^{T} g ( t ) sin ( 2 π nft ) d t & Equation 3 \\ {c}_{n} = \sqrt{{a}_{n}^{2} + {b}_{n}^{2}} & Equation 4\end{matrix}$$

Here, an and bn (n=0, 1, 2, and so on) are the nth Furrier coefficients and can be obtained by equations 2 and 3, respectively. Then, cn given by equation 4 corresponds to the amplitude of the spectral component of the frequency n·f, which is the value shown in the table.

Here, keeping in mind that, as described above, the frequency range in which the sensitivity of human eye to flicker is high is 40 Hz or less, and in particular, the visual sensitivity to flicker is high at 30 Hz or less, the spectral components of the conventional liquid crystal display device and the present invention are compared in this frequency range. The results are that the amplitude of the 10 Hz component of the present invention is reduced to 27.5% of the component of the conventional liquid crystal display device, and similarly, the 20 Hz and 30 Hz components of the present invention are reduced to 33.4% and 72.7%, respectively. From these results, it can be concluded that the flicker is very unlikely to be visible by means of the drive of the present invention.

Note that as described above, the flicker caused by the flexoelectric effect is not a problem in the normal 60 Hz drive, but the problem appears when the frame frequency is reduced to 40 Hz or less to perform the intermittent drive. Thus, it can be said that the present invention obtains a significant flicker reduction effect in particular at the frame frequency of 40 Hz or less.

The ratio between a voltage V1 applied in a first scanning period and a second voltage V2 applied in a second scanning period shown in FIG. 6A should be in a range with the flicker reduction effect and not deteriorating the reproducibility of the image. This range is, for example, about from 0.1% to 3% with respect to the voltage V1 in the first scanning period and the voltage V2 in the second scanning period. The voltage range corresponds to the range from 3 mV to 90 mV, when the voltage in the second scanning period is approximately 3 V.

The above description has focused on the configuration in which the pixel electrode is present on the upper side of the counter electrode through the insulating film. However, the present invention is also applicable to a configuration in which the counter electrode is present on the upper side of the pixel electrode through the insulating film. In this case, the pixel electrode is formed in a matted manner and the counter electrode has a comb shape or slit.

As described above, according to the present invention, it is possible to provide a liquid crystal display device capable of preventing the occurrence of flicker in the application of the low frequency drive or intermittent drive and achieving excellent display quality, as well as a driving method of the liquid crystal display device.

What is claimed is:

1. A liquid crystal display device comprising:
an array substrate including scanning lines extending in a first direction and arranged in a second direction, video signal lines extending in the first direction and arranged in the second direction, and a pixel formed in a region surrounded by the scanning lines and the video signal lines;
a counter substrate; and
a liquid crystal interposed between the array substrate and the counter substrate,
wherein in the pixel a comb-shaped second electrode is placed on a planar first electrode through an insulating film,
wherein when the period of rewriting a video signal to a pixel is one frame, the frame is configured with a first scanning period, a second scanning period, and a break period,
wherein the voltage supplied to the pixel electrode in the first scanning period is greater than the voltage supplied to the pixel electrode in the second scanning period with respect to the same video signal, and has the same polarity as the polarity of the voltage supplied to the pixel electrode in the second scanning period.

2. A liquid crystal display device according to claim 1,
wherein the voltage supplied to the pixel electrode in the first scanning period is greater by 0.1% to 3% than the voltage supplied to the pixel electrode in the second scanning period.

3. A liquid crystal display device according to claim 1,
wherein the second scanning line is configured with a plurality of scanning periods.

4. A driving method of a liquid crystal display device comprising:
an array substrate including scanning lines extending in a first direction and arranged in a second direction, video signal lines extending in the second direction and arranged in the first direction, and a pixel formed in a region surrounded by the scanning lines and the video signal lines;
a counter substrate; and
a liquid crystal interposed between the array substrate and the counter substrate,
wherein in the pixel a comb-shaped second electrode is placed on a planar first electrode through an insulating film,
wherein when the period of rewriting a video signal to a pixel is one frame, the frame is configured with a first scanning period, a second scanning period, and a break period,
wherein the voltage supplied to the pixel in the first scanning period is greater than the voltage supplied to the pixel electrode in the second scanning period with respect to the same video signal, and has the same polarity as the polarity of the voltage supplied to the pixel electrode in the second scanning period.

5. A driving method of a liquid crystal display device according to claim 4,
wherein the voltage supplied to the pixel electrode in the first scanning period is greater by 0.1% to 3% than the voltage supplied to the pixel electrode in the second scanning period with respect to the same video signal.

6. A driving method of a liquid crystal display device according to claim 4,
wherein the second scanning period is configured with a plurality of scanning periods.

7. A liquid crystal display device comprising:
an array substrate including scanning lines extending in a first direction and arranged in a second direction, video signal lines extending in the second direction and arranged in the first direction, and a pixel formed in a region surrounded by the scanning lines and the video signal lines;
a counter substrate;
a liquid crystal interposed between the array substrate and the counter substrate; and
a control circuit,
wherein in the pixel a comb-shaped second electrode is placed on a planar first electrode through an insulating film,
wherein the control circuit has means to perform normal drive at a frame frequency of 40 Hz or more, and intermittent drive at a frame frequency of 40 Hz or less,
wherein in the intermittent drive operation, when the period of rewriting a video signal to a pixel is one frame, the frame for performing the intermittent drive is configured with a first scanning period, a second scanning period, and a break period,
wherein the voltage applied to the pixel electrode in the first scanning period is greater than the voltage supplied to the pixel electrode in the second scanning period with respect to the same video signal, and has the same polarity as the polarity of the voltage supplied to the pixel electrode in the second scanning period.
